(19) United States
(12) Patent Application Publication
(10) Pub. No.: US 2021/0268929 A1
(43) Pub. Date: Sep. 2, 2021

(54) CHARGING SYSTEM FOR ELECTRIC VEHICLES

(71) Applicant: Stephan Cater, Dortmund (DE)

(72) Inventor: Stephan Cater, Dortmund (DE)

(73) Assignee: innogy SE, Essen (DE)

(21) Appl. No.: 17/324,564

(22) Filed: May 19, 2021

Related U.S. Application Data
(63) Continuation of application No. PCT/EP2019/081491, filed on Nov. 15, 2019.

(30) Foreign Application Priority Data
Nov. 21, 2018 (DE) 10 2018 129 335.6

(51) Int. Cl. B60L 53/67; B60L 53/65

(52) U.S. Cl. CPC B60L 53/67; B60L 2260/44; B60L 2250/20; B60L 53/65

(57) ABSTRACT

A charging system for electric vehicles that includes a plurality of charging stations each adapted to exchange electrical power with at least one electric vehicle. At least one charging profile determination module adapted to: obtain a charging station identifier associated with a first charging station of the plurality of charging stations and a user identifier associated with a user of an electric vehicle to be charged at the first charging station during a charging process. Determining based on the obtained user identifier and the obtained charging station identifier, at least one historical charging process data set relating to the user identifier and the charging station identifier. Estimating at least one charging parameter for the charging process based on the at least one historical charging process data set, and determining the charging curve profile for the charging process based on at least the at least one estimated charging parameter.

### CROSS-REFERENCE TO RELATED PATENT APPLICATIONS

This patent application is a continuation of International Application No. PCT/EP2019/081491, filed on Nov. 15, 2019, which claims the benefit of priority to German Patent Application No. 10 2018 129 355.6, filed Nov. 21, 2018, the entire teachings and disclosures of both applications are incorporated herein by reference thereto.

### FIELD OF INVENTION

The application relates to a charging system for electric vehicles, comprising a plurality of charging stations, each configured to exchange electrical power with at least one electric vehicle. In addition, the application relates to a method for operating a charging system.

### BACKGROUND

Charging systems for charging electric vehicles are known from the prior art. Known charging systems comprise one or more charging station(s), which may be communicatively coupled to a backend system. A charging station may comprise at least one charging point to which an electric vehicle to be charged can be electrically connected. For example, the charging point may be a charging cable fixedly attached to the charging station that may be connected to a charging port of the electric vehicle. Alternatively, the charging point may be a charging port at the charging station that can be connected to a charging cable.

Typically, prior to starting a charging process between a charging station and an electric vehicle, a charging curve profile is established for the charging process to be carried out. The charging curve profile to be defined is based at least on the maximum power P_{L_max} available at the charging station. In particular, the maximum available power P_{L_max} is the maximum permissible deliverable (total) power at the charging station.

FIG. 1 presents a schematic view of exemplary charging curve profiles at a charging station from practice. In particular, the power curve P is plotted against time t.

In the present example, it is first assumed that the charging station comprises at least two charging points. It is also possible that a charging station arrangement is provided with two or more charging stations arranged adjacent to each other, i.e. coupled to the same power grid section.

With a first charging curve profile 102 between time point to and time point t₂, a power P₁ is reserved for this period for a first charging process of a first electric vehicle at the charging station. In particular, power P₁ is in principle reserved and kept available for the first electric vehicle for the charging process up to a time point t₂. The power P₁ can, for example, be the maximum permissible charging power of the electric vehicle.

At time point t₁, a second charging process is requested by a second electric vehicle at the charging station. For this, a second power is reserved by a second charging curve profile 104. As can be seen, the power that can be delivered to the second electric vehicle is limited by the maximum power P_{L_max} that can be delivered and the power P₁ already reserved for the first charging process.

Furthermore, it can be seen that no power can be made available for a further charging point of the charging station (or a further neighboring charging station) at least between time point t₁ and time point t₂.

As has already been described, by defining a charging curve profile, the corresponding power for the charging process of an electric vehicle is fixedly reserved for a specific period of time regardless of the actual demand/desire for electric power and energy, respectively. This can result in that the power available for charging a further electric vehicle at a charging station is limited during specific periods.

In order to optimize the operation and, in particular, the efficiency of a charging station, it is known from the prior art to take into account the state of charge of the electrical storage device to be charged, in particular, the traction battery, of the electric vehicle. Furthermore, a user interface (e.g., at the charging station and/or at a user terminal (e.g., smartphone, tablet, etc.)) is generally provided in known charging systems, which can be used by the user to enter the desired amount of energy and/or the desired charging duration. This allows the power reserved by the charging curve profile to be more accurately matched to the demand/desire for electrical power and energy, respectively.

Based on the state of charge and the desired amount of energy and/or the desired charging duration, for example, the power P₁ to be reserved from the above example can be reduced but the amount of energy can be the same by extending the charging duration so that more power is available for the second electric vehicle and/or power is still available for a third electric vehicle.

In practice, however, it has been shown in the operation of known charging systems that users rarely use the option to specify the desired amount of energy and/or the desired charging duration and charging process time duration, respectively, using the user interface.

One reason for this is that entering the information results in increased effort for the user. In addition, it is necessary for the user to determine and specify the desired amount of energy and/or the desired charging duration before each start of a charging process.

### BRIEF SUMMARY OF THE INVENTION

Therefore, the object of the application is to provide a charging system for charging electric vehicles that optimizes the operation of the charging stations, in particular, the efficiency of the charging stations, and at the same time increases the user friendliness.

The object is solved according to a first aspect of the application by a charging system for electric vehicles according to claim 1. The charging system comprises a plurality of charging stations. A charging station is configured to exchange electrical power with at least one electric vehicle. The charging system comprises at least one charging profile determination module. The charging profile determination module is configured to:
obtain a charging station identifier associated with a first charging station of the plurality of charging stations and a user identifier associated with a user of an electric vehicle to be charged at the first charging station during a charging process,
determining, based on the obtained user identifier and the obtained charging station identifier, at least one historical charging process data set relating to the user identifier and the charging station identifier,
estimating at least one charging parameter for the charging process based on the at least one historical charging process data set, and
determining the charging curve profile for the charging process based on at least the at least one estimated charging parameter.

In contrast to the prior art, according to the application, a charging system with a plurality of charging stations is provided, which optimizes the operation of the charging stations, in particular, the efficiency of the charging stations, and at the same time increases the user friendliness by basing the determination of the charging curve profile on historical, in particular, user-specific and charging position-specific, charging process data sets. The charging power to be reserved by a charging curve profile can be optimized. User inputs via a user interface module can be omitted.

The charging system according to the application comprises a plurality of charging stations. A charging station according to the application is meant to be a stationary device that enables the exchange of electrical energy between an electric vehicle and the electrical storage of the electric vehicle, respectively, and the stationary device. In particular, a charging station comprises at least one charging point, preferably a plurality of charging points, for coupling an electric vehicle to the charging station, for example, via a charging cable, so that electrical energy can be exchanged via the charging cable. As a charging point, a charging station may have, for example, at least one permanently attached charging cable and/or at least one charging port that may be coupled to a charging cable.

Further, the charging station may comprise charging technology to control the charging process.

The charging stations are located in different places and positions, respectively, in particular, in public spaces as well as in semi-public spaces. Two or more charging stations at the same location (for example, a same parking area) may be referred to as a charging station arrangement (or charging arrangement).

In the present context, an electric vehicle is understood to mean a vehicle, in particular, a car, that can be at least partially operated electrically and comprises at least one rechargeable electrical storage device, in particular, a traction battery.

Furthermore, the charging system comprises at least one charging profile determination module. The charging profile determination module may be arranged and implemented, respectively, in a charging station, a backend system of the charging system, and/or a computing device controlled, for example, by the backend system.

In particular, the charging profile determination module is configured to optimize a charging curve profile for a charging process based on historical charging processes of the user at the charging station at which the charging process is to be carried out.

For an optimization, the application, in particular, proposes to first evaluate a user identifier and a charging station identifier. In particular, prior to a charging process of an electric vehicle of a particular user at a particular (first) charging station, the charging station identifier of the charging station and the user identifier of the user can be obtained. At least system-wide, a charging station identifier may be uniquely assigned to a charging station and a user identifier may be uniquely assigned to a user.

Based on the obtained user identifier and the obtained charging station identifier, at least one historical charging process data set may be determined that comprises at least one recorded charging parameter (value) of a historical, i.e. previous, charging process. Preferably, at least one memory module may store a plurality of historical charging process data sets that are charging station identifier dependent and user identifier dependent. This is to be understood, in particular, as meaning that the memory module with the stored charging process data sets is searchable for a user identifier and a charging station identifier, so that these can be found, i.e. determined.

Based on the historical charging process data sets, at least one charging parameter, in particular, a plurality of charging parameters, can be estimated for the charging process to be performed. A charging parameter and charging parameter value, respectively, means a parameter (value) that influences the charging curve profile to be generated.

Based on the estimated at least one charging parameter, the charging curve profile for the charging process to be performed can be determined, in particular, generated. Subsequently, the charging process can be carried out at the charging station. It shall be understood that the charging curve profile determination may take into account the charging curve profiles already present at the charging station or the charging curve profiles present at the charging station arrangement of a charging station.

Preferably, the charging system may comprise an authentication module. The authentication module may be arranged and implemented, respectively, in a charging station, a backend system of the charging system, and/or a computing device, for example, controlled by the backend system. The authentication module may be configured to carry out an authentication process, in particular, before the start of the charging process at the first charging station. In particular, this may involve checking, at least based on the user identifier, whether or not the user is authorized to charge at the charging station (which is identifiable based on the charging station identifier).

Preferably, the user identifier used for the authentication process (e.g., a contract ID, user name, user address, etc.) can be provided to the charging profile determination module. Further, the charging station identifier (e.g., signature, unique address, unique geographic coordinates or similar position information, unique code, etc.) used in an authentication process may be provided to the charging station at which the user authenticates for a charging process.

As has already been described, the charging system may comprise at least one memory module configured to store user identifier dependent and charging station identifier dependent historical charging process data sets. The memory module may be arranged and implemented, respectively in a charging station, a backend system of the charging system, and/or a storage arrangement controlled, for example, by the backend system.

Particularly preferably, the charging profile determination module may be formed as a control module. As input variables for a control algorithm, the control module can receive at least the user identifier and the charging station identifier. Output variables may be, in particular, the optimized charging curve profile. When executing the control algorithm, the control module can preferably access the memory module in which the historical charging process data sets are stored, in accordance with the above explanations. In this regard, the memory module may be an integral part of the control module.

Preferably, the control module may be formed by a control module selected from the group comprising:
an extreme value controller,
a fuzzy controller,
a control model based on a machine learning algorithm,
a neural network, or
combinations thereof.

In particular, this can provide a self-learning charging system for electric vehicles.

In addition, the charging profile determination module may be configured to determine the charging curve profile based on at least one real-time information, in particular, a current power grid parameter. For example, a power grid parameter may be a power grid frequency, a harmonic, a voltage, and/or a current. The at least one power grid parameter can be detected by a further measuring device and made available to the charge profile determination module. It is possible that the further measuring device is arranged within a charging station. By taking a power grid parameter into account, the current grid status can be taken into account and the grid to which the charging station is coupled can be stabilized as a result, for example.

Preferably, the charging system comprises a backend system communicatively connected to the plurality of charging stations. Preferably, at least the charging profile determination module may be implemented in the backend system.

Preferably, the charging profile determination module may be configured to estimate the at least one charging parameter based on at least one historical load distribution of the power grid to which the first charging station is connected. In particular, the charging profile determination module may retrieve the historical load distribution from the (first) charging station at which the charging process is to be performed. The historical load distribution can be used to estimate what the average utilization of the supply power grid is at the time of the desired charging process. Such an average load can be time resolved, so that, for example, a time of day dependent and/or day of week dependent average load can be present. A time of day dependent average utilization may be, for example, a so called load forecast/load prediction.

According to a further embodiment of the charging system according to the application, the charging system may comprise at least one recording module. The recording module may be arranged in the charging station, a backend system of the charging system and/or a separate computing device controlled, for example, by the backend system.

The recording module may be configured to record charging processes performed at the plurality of charging stations. In particular, the at least one recording module can record (almost) every charging process, for example, with the help of suitable measurement sensors. Thus, the recording module may be configured to record performed charging processes of the at least one charging stations, in particular, to record the at least one charging parameter and charging parameter value, respectively, actually measured during a performed charging process. In particular, the memory module can be configured to store, in a user identifier dependent and charging station identifier dependent manner the recorded charging process, in particular, the at least one charging parameter actually measured during a charging process that has been carried out in the form of a user identifier dependent and charging station identifier dependent historical charging process data set.

According to a particularly preferred embodiment, the charging profile determination module may be configured to estimate the maximum permissible charging power of the charging process to be performed, the amount of energy to be transferred during the charging process to be performed, and/or the charging process time duration.

In other words, a charging parameter according to the application may, in particular, be the (maximum or average) charging power of the charging process to be performed (and the historical charging process, respectively), the amount of energy to be transferred (and transferred, respectively) during the charging process to be performed (and the historical charging process, respectively), or the charging process time duration of the charging process to be performed (and the historical charging process, respectively).

By estimating, in particular, a plurality of these parameters, the charging curve profile can subsequently be generated with a higher accuracy for the expected charging process.

Furthermore, according to a further embodiment of the charging system according to the application, a probability of occurrence may be associated with the at least one estimated charging parameter. In particular, the charging profile determination module may determine and assign a probability of occurrence and an expected value, respectively, to each estimated charging parameter. An example is shown in Table 1 below:

TABLE 1

| charging | estimated | | probability of |
|---|---|---|---|
| parameter | value | | occurrence |
| Pₘₐₓ | 3.7 | kW | 99% |
| Eₐₘₒ | 10 | kWh | 84% |
| Charging | 6 | h | 50% |
| duration | | | |

Here, Pₘₐₓ is the estimated maximum charging power (to be reserved), Eₐₘₒ is the estimated amount of energy (to be transferred), and the charging duration is the estimated time duration during which the electric vehicle will be coupled to the charging station.

The charging profile determination module may be configured to determine the charging curve profile for the charging process based at least on the at least one estimated charging parameter and the associated probability of occurrence. For example, if the charging duration is estimated to be 6 h with an expected value of 100%, the charging profile may have a duration of 6 h (possibly with a predefinable safety tolerance) and the estimated amount of energy (with an expected value of 100%) may be distributed over those 6 h. However, if the charging duration of 6 his only estimated with an expected value of 50%, the charging profile may have a duration of 3 h (if necessary with a predeterminable safety tolerance) and the estimated amount of energy (with an expected value of 100%) may be distributed over these 3 h (if it is possible).

In addition, the charging profile determination module may be configured to determine the at least one historical charging process data set based on a charging start time point (e.g., a time point of day and/or a day of the week) of the charging process. This may further optimize the determination of the charging curve profile.

For example, on a particular day of the week, the user may regularly connect his vehicle to a particular charging station for a first (approximate) charging duration, while on another day of the week, the user may regularly connect his vehicle to the particular charging station for a different (approximate) charging duration, which may be different, for example, significantly, from the first charging duration.

Preferably, the charging profile determination module may be configured to estimate the at least one charging parameter based on the (current) state of charge (in particular, the charging capacity) of the battery of the electric vehicle to be charged. In particular, the state of charge, in particular, the current charge capacity of the battery of the electric vehicle to be charged, can be queried before the charging process is started. Depending on the state of charge, the at least one charging parameter can be estimated with a higher accuracy. It shall be understood that optionally also information about the charging process duration and/or the desired energy amount can be obtained by a user interface and taken into account in the estimation.

According to a further preferred embodiment of the charging system according to the application, the charging profile determination module may be configured to estimate the distance to be driven by the electric vehicle after the charging process based on at least one user data set associated with the user identifier. The user data set may be a position information, in particular, a home address and/or a workplace address. The position information may be determined from a user account, for example. In this embodiment, it is advantageously possible to estimate how far a user may need or want to travel with his electric vehicle. For example, if a user charges his electric vehicle at a charging station at his workplace during his working hours, it is particularly important that the battery of the electric vehicle has at least enough energy at the end of his working hours to allow the user to drive from his workplace to his home without any further intermediate stop. A determination of a charging curve profile can, for example, be designed in such a way that the battery of the electric vehicle contains at least enough energy after a specific charging duration that a user can drive from the charging station at the workplace where the electric vehicle is charging to his place of residence without a further intermediate stop. For this purpose, advantageously, position information (e.g., a geographic information) of the charging station and the information of the place of residence (e.g., a geographic information) can be used to determine the charging curve profile.

Preferably, other available user data may alternatively or additionally be considered by the charging profile determination module, such as working time data of the user. In particular, user-specific data (which can be stored in a user account) can include a user group of the user. For example, it is conceivable that such a user group is assigned to a specific shift work. Advantageously, this makes it possible to estimate the departure time of a user and thus the charging process duration with an increased probability and accuracy, respectively. Example: a user is a worker and wants to charge his electric vehicle during his working hours. For example, the shift work of the worker extends from 6:00 am to 2:00 pm. Thus, the worker may belong to the “early shift” user group, for example. It is very unlikely that the worker will already drive home with his electric vehicle at 10:00 am. The predicted time at which the charging process must be successfully completed, i.e. the estimated charging process time duration, is approximately 2:00 pm in the example. Such information can be used in determining a charging curve profile.

As has already been described, the charging system may include at least one memory module. In the memory module, according to a further embodiment of the charging system according to the application, a plurality of charging station identifiers may be stored. At least one charging station identifier, preferably (almost) each charging station identifier, may be assigned (in each case) at least one functional attribute of the parking area assigned to the charging station. For example, the function attribute may indicate the purpose for which the parking area is used (for example, for parking an electric vehicle while working, or shopping, etc.). The charging profile determination module may be configured to estimate the at least one charging parameter based on the at least one functional attribute. The generation of the charging profile may be further optimized.

It shall be understood that two or more memory modules may be provided.

According to a further embodiment of the charging system according to the application, the charging profile determination module may be configured to determine the further charging station used by the user (within a specific predeterminable time period) in at least one previous charging process. The charging profile determination module may be configured to determine a distance between the further charging station used in the previous charging process and the first charging station. The charging profile determination module may be configured to estimate the at least one charging parameter based on the determined distance. In particular, based on the determined distance, it may be estimated how much energy the electric vehicle consumed to complete the distance. As a result, the energy requirement and the amount of energy, respectively, of the electric vehicle during the charging process to be performed can be estimated with a higher accuracy. The generation of the charging curve profile can be further optimized.

Particularly preferably, a particular charging curve profile may have a plurality of charging curve intervals. The charging system may comprise at least one charging curve profile adaptation module. The charging curve profile adaptation module may be arranged and implemented, respectively, in a charging station, a backend system of the charging system, and/or a computing device controlled, for example, by the backend system. The charging curve profile adaptation module may be configured to adapt at least one of the charging curve intervals during the execution of the charging process based on at least one real-time information. A charging curve interval may preferably have a time span of 15 minutes. At the beginning of a charging process, a charging curve profile is determined, as described above. For example, after each charging curve interval (or at other times) of the charging process, the previously determined charging curve profile can be adjusted taking into account current real-time information, in particular, at least one power grid parameter (e.g., power grid frequency, harmonic, voltage and/or current) (and possibly other historical data).

For example, if after a specific number of charging curve intervals a difference is detected between the predicted average utilization of the supply power grid and the current utilization, the charging curve profile determined at the beginning of the charging process can be adapted with respect to the detected difference. For example, it is unlikely that an employee will show up for work after three hours of the actual start of work. For example, if after three hours it is determined that said worker is not charging his electric vehicle at work (as is otherwise usual), then the scheduled resources conditioned based on the other historical data can be released.

Advantageously, by using the charging curve intervals and, in particular, the possible adaptation of the charging curve profile, an optimal utilization can be achieved. Advantageously, the use of charging curve intervals can limit the degree of complexity of the control module, since in one embodiment (always) only a part (the period of a few load curve intervals) of the load curve profile can be calculated.

Further, a dynamic prioritization of a user during the charging process may be used to determine the charging curve profile. Dynamic prioritization of a user may be used when the charging process has multiple charging curve intervals and, as previously mentioned, the charging curve profile of the charging process may be adjusted. A dynamic prioritization may be based on the user-specific data and/or the other historical data and/or the current real-time information.

Example: If, based on user-specific data, it is determined by a computer-aided evaluation (e.g., by the charging profile determination module) that a user would like to use the electric vehicle to be charged with a very high probability at 3:00 pm and at 2:00 pm the current state of charge of the electric vehicle (and battery, respectively) is not yet sufficient for a desired mobility, then the charging curve profile of the charging process, in particular, the charging power, can be changed between 2:00 pm and 3:00 pm in such a way that the desired mobility can be ensured at 3:00 μm. The user thus receives a high dynamic prioritization value at 2:00 pm in the example, which can result in that in the course of the charging curve profile determination according to the application a high proportion of the maximum available power is supplied to the electric vehicle of the user at the charging station.

A further aspect of the application is a method for operating a charging system, in particular a previously described charging system. The method comprises:
obtaining a charging station identifier associated with a first charging station and a user identifier associated with a user of an electric vehicle to be charged at the first charging station during a charging process,
determining, based on the obtained user identifier and the obtained charging station identifier, at least one historical charging process data set relating to the user identifier and the charging station identifier,
estimating at least one charging parameter for the charging process based on the at least one historical charging process data set, and
determining the charging curve profile for the charging process based on at least the at least one estimated charging parameter.

It shall be understood that the above described modules and units may each be formed at least in part by hardware elements and/or software elements and may be arranged and implemented, respectively, in a distributed manner, as the case may be.

The features of the charging systems and methods can be freely combined with each other. In particular, features of the description and/or of the dependent claims can be independently inventive, even by completely or partially bypassing features of the independent claims, in sole position or freely combined with each other.

### BRIEF DESCRIPTION OF THE FIGURES

There is now a plurality of possibilities for designing and further developing the charging system according to the application and the method according to the application. In this connection, reference is made on the one hand to the patent claims subordinate to the independent patent claims, and on the other hand to the description of embodiments in connection with the drawing. The drawing shows:

FIG. 1 a diagram showing exemplary charging curve profiles according to the prior art,

FIG. 2 a schematic view of an embodiment of a charging system according to the present application,

FIG. 3 a diagram showing exemplary charging curve profiles according to the present application, and

FIG. 4 a diagram of an embodiment of a method according to the present application.

In the following, similar reference signs are used for similar elements.

### DETAILED DESCRIPTION

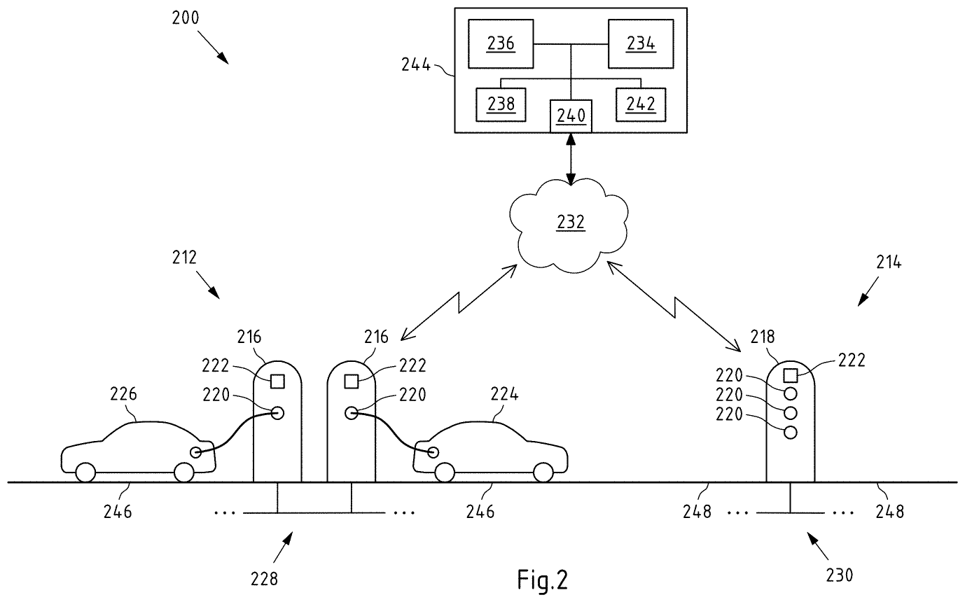

FIG. 2 shows a schematic view of an embodiment of a charging system 200 according to the present application. The charging system 200 comprises a plurality of charging stations 216, 218 and at least one charging profile determination module 234, for example, in the form of a control module, such as a neural network or a control model based on a machine learning algorithm.

In the present example, in particular, two charging stations 216 each having one charging point 220 are grouped into a charging (station) arrangement 212. The charging arrangement 212 and the charging stations 216 of the charging arrangement 212, respectively, are connected to a first supply power grid 228, for example, a first local power grid 228, and are located at a first location.

Further, by way of example, a further charging station 218 having three charging points 220 is arranged. In the present embodiment, the charging station 218 is connected to a further supply power grid 230, for example, a further local power grid 230, and is positioned at a further location.

A charging point 220 may be formed, for example, in the form of a fixedly attached charging cable. Further, a charging station 216, 218 may include a charging controller and (not shown) charging technology, respectively. In a charging arrangement 212, a common charging control system may also be provided.

Each charging station 216, 218 is configured to exchange electrical power with a connected electric vehicle 224, 226 in the course of a charging process. In particular, a charging station 216, 218 can supply electrical power to an electric vehicle 224, 226 for charging a vehicle battery. Each charging station 216, 218 obtains the deliverable electrical energy and power, respectively, from the respective power grid 228, 230. A (not shown) charging control system, in particular, comprising a rectifier, may also be arranged within an electric vehicle 224, 226.

In the present embodiment, the charging profile determination module 234 is arranged and implemented, respectively, in a backend system 244. It shall be understood that in other variants of the application, at least this module may also be (at least partially) arranged and implemented, respectively, in a charging station.

As can be seen, the charging stations 216, 218 are connected to the backend system 244 (e.g., one or more servers) via a (wireless and/or wired) communication network 232. For communication, the respective elements 216, 218, 234 may comprise suitable communication modules 222, 240.

Optionally, the charging system 200 may comprise at least one memory module 236, an authentication module 238, and a charging curve profile adjustment module 242. In the present embodiment, these optional modules 236, 238, and 242 are also implemented in the backend system 244. Again, it shall be understood that in other variants of the application, at least a portion of these modules may also be (at least partially) disposed and/or implemented in a charging station (or another computing device).

Furthermore, it can be seen that parking areas 246 for electric vehicles 224, 226 to be charged are provided at the charging station arrangement 212 and the charging stations 216, respectively. The further charging station 218 also has parking areas 248. For example, the charging station 218 may be located in a supermarket parking lot 248 and the charging station arrangement 212 may be located in a company parking lot 246.

Each charging station 216, 218 may be assigned a charging identifier that is unique, in particular, system-wide. In addition, users may be registered in the charging system and have, for example, a user account in which user data, such as a user identifier uniquely identifying the user, payment data, address data, etc., may be stored. The charging identifiers and the registered user identifiers may be stored, for example, in the memory module 236.

Functional attributes may be associated to the charging station identifiers. For example, the charging station identifiers of the charging stations 216 may be assigned (respectively) the functional attribute “company parking lot” or long-term parking lot, and the charging station 218 may be assigned “supermarket” or short-term parking lot. It shall be understood that other designations may be selected.

In addition, in the memory module 236 a plurality of historical user identifier dependent and charging station identifier dependent charging process data set may be stored. For example, by means of a recording module (not shown), the actual charging parameters, such as the charging power (maximum or average) of a performed charging process, the transferred amount of energy of the performed charging process, and/or the charging process time duration of the performed charging process, may be recorded and stored, for example, in a searchable database of the memory module 236. In particular, the database may be searchable by user identifier and charging station identifier.

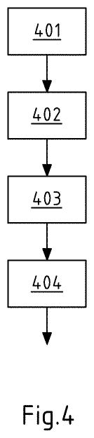

The functionality and the operation, respectively, of the charging system 200 is described in more detail below with reference to FIG. 4. FIG. 4 shows a diagram of an embodiment of a method according to the present application.

In a first step 401, a charging station identifier associated with a first charging station 216 and a user identifier associated with a user of an electric vehicle 224, 226 to be charged at the first charging station 216 during a charging process may be obtained, by the charging profile determination module 234.

For example, this may be done as part of an authorization process prior to the start of a charging process. During the authorization process and authorization procedure, respectively, in particular, the charging station 216 may communicate with the backend system 244 and, in particular, provide to the authentication module 238 and preferably to the charging profile determination module 234 at least the user identifier of the user of the electric vehicle 224 to be charged and the charging station identifier of the charging station 216 at which the electric vehicle 224 will be charged. It shall be understood that the user identifier and the charging station identifier may also be provided to the charging profile determination module 234 in other ways.

In a next step 402, which may be part of a control algorithm, at least one historical charging process data set relating to the user identifier and the charging station identifier may be determined by the charging profile determination module 234 based on the obtained user identifier and the obtained charging station identifier. Preferably, a plurality of charging process data sets may be determined.

In particular, the charging profile determination module 234 may access the charging process data sets stored in the database and determine the historical charging process data sets associated with the obtained user identifier and charging station identifier, in particular, the historical charging parameters contained therein.

Preferably, the charging start time point of the (requested) charging process can be determined and taken into account when determining the historical charging process data sets.

In step 403, which may also be part of the control algorithm, at least one charging parameter for the charging process to be performed may be estimated based on the at least one historical charging process data set, in particular, the plurality of historical charging parameters. For example, the charging parameters may be estimated according to Table 1. In particular, each historical charging parameter may have an associated probability of occurrence that may be considered in the estimation.

Further, optionally at step 403, the charging profile determination module 234 may be configured to estimate the at least one charging parameter based on the state of charge of the battery of the electric vehicle 224 to be charged and/or the at least one functional attribute of the charging station 216.

For example, the charging station 216 may request the state of charge of the battery to be charged of the electric vehicle 224 from the electric vehicle 224 and forward the received state of charge to the backend system 244. This may also optionally be taken into account in the estimation at step 403.

Also, a previous distance traveled between a charging station previously used and the charging station 216 where charging is to be performed and/or a distance to be traveled after charging, for example, from the company parking lot to the residence of the user, may be taken into account in step 403.

Then, in step 404, the charging curve profile for the charging process to be performed can be determined, in particular, generated, at least based on the at least one estimated charging parameter. In particular, a plurality of charging parameters, such as a maximum charging power, a charging process duration and/or amount of energy to be transferred can be estimated and taken into account in step 404 for determining the charging curve profile.

After the charging curve profile has been determined, in particular, generated, the charging process can be carried out, at least if the authentication result is positive.

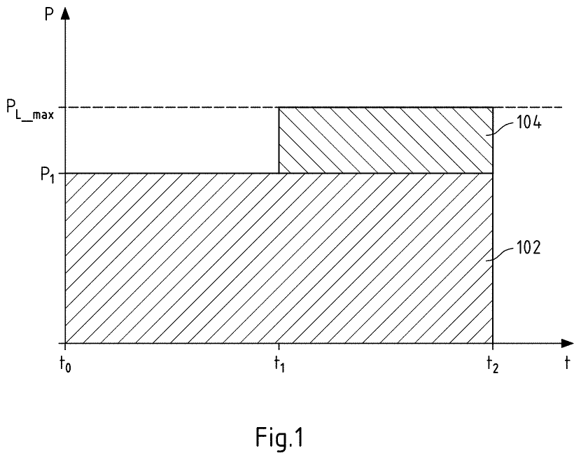

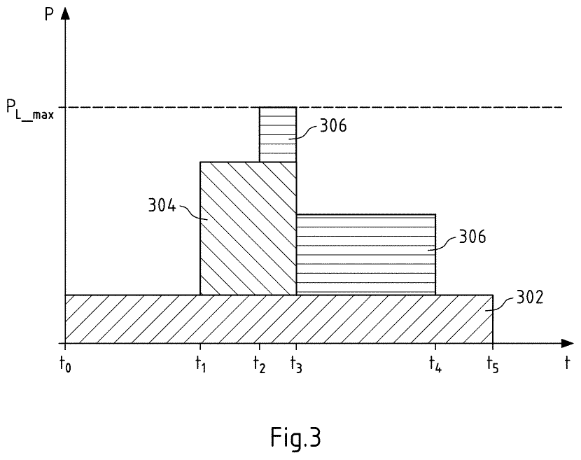

Exemplary charging curve profiles according to the present application at a charging station are shown in FIG. 3. For a first charging process, based on an estimated charging process duration of at least t₀ to t₅, a charging curve profile 302 with a (lower compared to FIG. 1) maximum charging power can be reserved. However, due to the longer reserved charging duration, the same amount of energy may be reserved for the charging process (compared to FIG. 1). This allows a charging curve profile 304 with a higher (compared to FIG. 1) maximum charging power to be reserved for a second charging process with an estimated shorter charging process duration from t₁ to t₃. Furthermore, for a third charging process with an estimated charging process duration from t₂ to t₄, a charging curve profile 306 with a further maximum charging power can be reserved.

Advantageously, as has been described above, in the present application, the position information of the charging station with respect to the user's historical data may be taken into account in determining the charging curve profile. For example, the user may charge his electric vehicle at a company parking lot of his employer. Such a charging process is, with regard to the time available for the charging process, a different charging process, which is carried out, for example, during a shopping trip in the parking lot of a supermarket.

The historical data of the user to be used for determining the charging curve profile can be available in particular filtered by position information. That is, only the user's historical data at a particular location or charging station is used to determine the charging curve profile. In a further embodiment, the user-specific data may include prioritization information of the user. Advantageously, this makes it possible for a charging curve profile to be determined taking prioritization into account. For example, users who always charge for a short period of time at a charging station can be prioritized higher than users who usually charge their electric vehicle for a long period of time at a charging station.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1) Charging system for electric vehicles, comprising:
a plurality of charging stations each configured to exchange electrical power with at least one electric vehicle,
at least one charging profile determination module configured to:
obtain a charging station identifier associated with a first charging station of the plurality of charging stations and a user identifier associated with a user of an electric vehicle to be charged at the first charging station during a charging process,
determining, based on the obtained user identifier and the obtained charging station identifier, at least one historical charging process data set relating to the user identifier and the charging station identifier,
estimating at least one charging parameter for the charging process based on the at least one historical charging process data set, and
determining the charging curve profile for the charging process based on at least the at least one estimated charging parameter.

2. Charging system of claim 1, wherein
the charging profile determination module is configured to estimate the maximum allowable charging power for the charging process, the amount of energy for the charging process and/or the charging process time duration.

3. Charging system according to claim 1, wherein
the at least one estimated charging parameter is assigned a probability of occurrence, and
the charging profile determination module is configured to determine the charging curve profile for the charging process at least based on the at least one estimated charging parameter and the associated probability of occurrence.

4. Charging system according to claim 1, wherein
the charging profile determination module is configured to determine the at least one historical charging process data set based on a charging start time point of the charging process.

5. Charging system according to claim 1, wherein
the charging profile determination module is configured to estimate the at least one charging parameter based on the state of charge of the battery of the electric vehicle to be charged.

6. Charging system according claim 1, wherein
the charging profile determination module is configured to estimate the distance to be traveled by the electric vehicle after charging process based on at least one user data set associated with the user identifier,
wherein the user data set is a position information, in particular, a residence address and/or workplace address.

7. Charging system according to claim 1, wherein
the charging system comprises at least one memory module,
wherein in the memory module a plurality of charging station identifiers is stored, wherein at least one charging station identifier is associated at least one functional attribute of the parking area associated with the charging station, and
the charging profile determination module is configured to estimate the at least one charging parameter based on the at least one feature attribute.

8. Charging system according to claim 1, wherein
the charging profile determination module is configured to determine the further charging station used by the user in at least one previous charging process,
the charging profile determination module is configured to determine a distance between the further charging station used in the previous charging process and the first charging station, and
the charging profile determination module is configured to estimate the at least one charging parameter based on the determined distance.

9. Charging system according to claim 1, wherein
a determined charging curve profile comprises a plurality of charging curve intervals, and
the charging system comprises at least one charging curve profile adjustment module configured to adjust at least one of the charging curve intervals during the performing of the charging process based on at least one real-time information.

10. Method of operating a charging system, in particular, a charging system according to claim 1, comprising:
obtaining a charging station identifier associated with a first charging station and a user identifier associated with a user of an electric vehicle to be charged at the first charging station during a charging process,
determining, based on the obtained user identifier and the obtained charging station identifier, at least one historical charging process data set relating to the user identifier and the charging station identifier,
estimating at least one charging parameter for the charging process based on the at least one historical charging process data set, and
determining the charging curve profile for the charging process based on at least the at least one estimated charging parameter.
